(19) United States
(12) Patent Application Publication
(10) Pub. No.: US 2026/0122020 A1
(43) Pub. Date: Apr. 30, 2026

(54) AUTOMATED PROMPT ENGINEERING USING HIERARCHICAL CLUSTERING FOR LARGE LANGUAGE MODELS

(71) Applicant: ServiceNow, Inc., Santa Clara, CA (US)

(72) Inventors: Venkatesh Gunda, Sunnyvale, CA (US); Rohit Dikshit, Fremont, CA (US)

(21) Appl. No.: 18/925,766

(22) Filed: Oct. 24, 2024

(51) Int. Cl. H04L 51/216; G06F 40/30

(52) U.S. Cl. CPC H04L 51/216; G06F 40/30

(57) ABSTRACT

Embodiments of the subject technology relate to systems, methods, and computer-readable media for engineering prompts for suggesting communications. Conversation data indicating a conversation between a virtual agent and an individual can be obtained. A plurality of contextual labels respectively associated with a plurality of stages of the conversation can be inferred via an LLM. The plurality of stages can be hierarchically clustered by applying a similarity criterion to the plurality of contextual labels.

### BACKGROUND

### 1. Technical Field

The present disclosure generally relates to prompt engineering for large language models (LLMs), and more specifically to prompt engineering for LLMs using hierarchical clustering.

### 2. Introduction

Virtual agents have been developed to communicate with individuals in various scenarios. For example, virtual agents are used to communicate with customers in customer service scenarios. In some situations, a virtual agent communicates with an individual before a human agent joins the conversation. Having the virtual agent solely communicating with the individual can be advantageous as the virtual agent can gather information without involving the human agent. As follows, the human agent can replace the virtual agent once the conversation has progressed and send a message to the individual. However, current techniques do not enable an efficient informational transfer between the virtual agent and the human agent.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a diagram of an example cloud computing architecture, according to some examples of the present disclosure;

FIG. 1B is a block diagram illustrating an example network architecture that can be used to implement one or more embodiments, components, devices, nodes, systems, instances, and/or portions of the example cloud computing architecture, according to some examples of the present disclosure;

FIG. 2 illustrates a schematic diagram of a communication environment, according to some examples of the present disclosure;

FIG. 3 illustrates a schematic diagram of an architecture 300 for generating a hierarchical clustering of conversation stages, according to some examples of the present disclosure;

FIG. 4 illustrates a flowchart 400 of an example method of generating a hierarchical clustering of stages of conversations, according to some examples of the present disclosure;

FIG. 5 illustrates an architecture 500 for generating a prompt for generating a suggested communication in a conversation through application of a hierarchical clustering of conversation stages, according to some examples of the present disclosure;

FIG. 6 illustrates a flowchart 600 of an example method of generating a prompt through a hierarchical clustering of stages of conversations for inferring a suggested communication in a current conversation, according to some examples of the present disclosure;

FIG. 7 is an example of a deep learning neural network that can be used to implement all or a portion of the systems and techniques described herein, according to some examples of the present disclosure;

FIG. 8 is a diagram illustrating an example architecture of an example transformer model, according to some examples of the present disclosure;

FIG. 9 illustrates an example processor-based system with which some embodiments of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

As discussed previously, Virtual agents have been developed to communicate with individuals in various scenarios. For example, virtual agents are used to communicate with customers in customer service scenarios. In some situations, a virtual agent communicates with an individual before a human agent joins the conversation. Having the virtual agent solely communicating with the individual can be advantageous as the virtual agent can gather information without involving the human agent. As follows, the human agent can replace the virtual agent once the conversation has progressed and send a message to the individual. However, current techniques do not enable an efficient informational transfer between the virtual agent and the human agent. In particular, the human agent can send a message that is generated based on a context of the conversation between the virtual agent and the individual up to the point where the human agent joins the conversation. However, it can be time consuming for a human agent to ascertain the context of the conversation and formulate the message to send to the individual based on such context. Large Language Models (LLMs) can be used to generate a suggested communication for the human agent based on the context of the conversation. However, accurately creating prompts for an LLM to generate the suggested communication for the human agent can be difficult due to differences in contexts and stages associated with various conversations. In particular, it can be difficult to create a generalized prompt that can be applied to the LLM across various conversations to create an accurate message that is applicable in each of the conversations.

The disclosed technology addresses the foregoing by accessing a hierarchy of stages of conversations that are grouped based on context similarity between the stages of the conversations and organized based on context specificity associated with the stages. Then, stages of a current conversation can be mapped to stages in the hierarchy, e.g. based on context and context specificity, to generate a prompt. Specifically, the prompt can be generated based on the contexts associated with the mapped stages in the hierarchy and therefore be specific to the current conversation. As follows, the prompt can be used to generate a suggested communication for the current conversation that is both accurate and relevant to the conversation.

Further, the disclosed technology can enable domain adaptation and increased domain specificity without the need for model weight adjustment. In turn, this approach can be a more generic approach that fine tuning approaches. The advantageous of this are numerous including less computationally expensive, less data intensive, and overall less restrictive when compared to fine-tuning approaches.

Labeling data for LLM prompt generation is difficult to scale. In particular, in the field of chat agents, a large number of conversations of a wide array of different contexts exist. As follows, it can be difficult to label the different stages in such conversations for purposes of generating LLM prompts across the different conversations.

The disclosed technology addresses the foregoing by automatically labeling and relabeling/generating label updates, through an LLM, stages of conversations based on contexts associated with the stages. The contextual labels and contexts associated with the stages can then be used to group and organize samples within a hierarchy of stages. Grouped samples can be merged and the merged samples can be re-labeled with the LLM. As follows, the hierarchy can be refined using the re-labeled samples. This can be done in an automated process using the LLM and a hierarchical clustering technique, thereby eliminating a need for tedious data labeling. Further, the technology can be applied across different LLMs to generate various hierarchies that account for differences across the LLMs. This can be done in an automated manner without having to manually re-label stages of the same conversation that are created across the different LLMs.

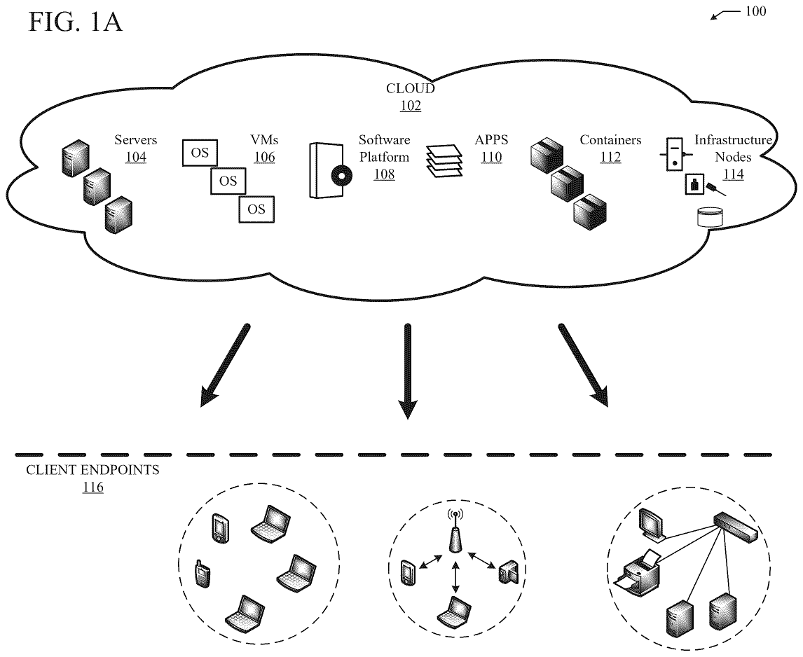

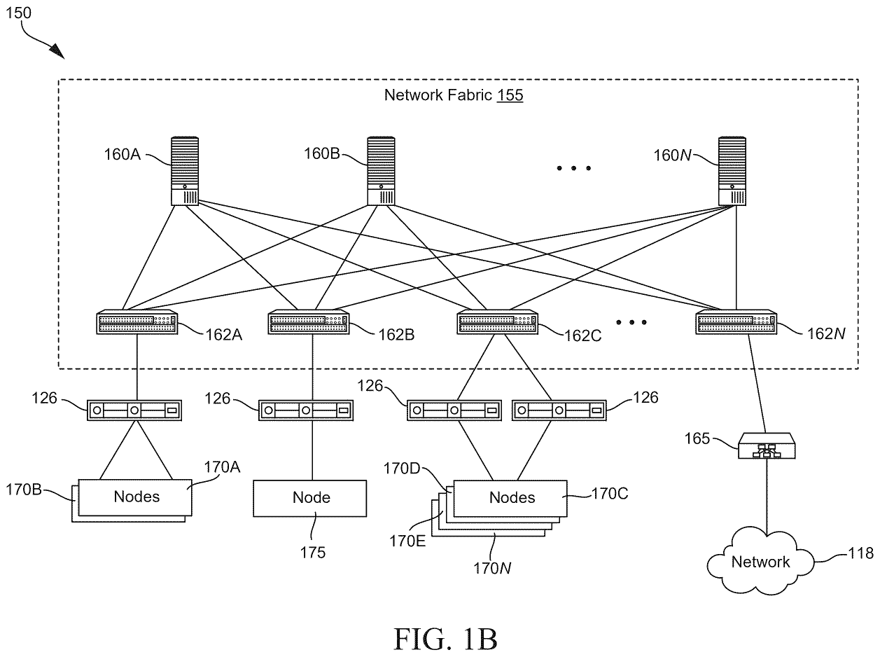

FIG. 1A illustrates a diagram of an example cloud computing architecture 100. The architecture can include a cloud 102. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can provide various cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, or any smart or connected object (e.g., smart home, smart building, smart retail, smart glasses, etc.), and so forth.

In some cases, one or more embodiments, components, devices, nodes, systems, instances, and/or portions of the example cloud 102 can be implemented by and/or in a cloud network or datacenter. For example, any portion (or all) of the network 118, any of the content servers 120 (or all), and/or any of the system servers 126 (or all) can be implemented by and/or in a cloud network or datacenter. An example network architecture that can be used to implement any such network or datacenter (or any portion thereof), is shown in FIG. 1B and further described below.

FIG. 1B is a block diagram illustrating an example network architecture 150 that can be used to implement one or more embodiments, components, devices, nodes, systems, instances, and/or portions of the example cloud computing architecture 100, according to some examples of the present disclosure. The example network architecture 150 in FIG. 1B can represent, implement, deploy, host, support, include and/or provide the infrastructure for (or a portion of the infrastructure for) a datacenter (e.g., a cloud datacenter, an on-premises datacenter, a hybrid datacenter including private and public datacenters or datacenter portions, etc.), a network infrastructure, and/or any network environment (or portion thereof) such as, for example and without limitation, a cloud network/environment, a campus network/environment, an enterprise network/environment, an on-premises network/environment, a private network/environment, a public network/environment, a hybrid network/environment (e.g., a network/environment including both private and public networks/environments or portions thereof), and/or the like.

In some examples, the example network architecture 150 can host, implement, deploy, provide (e.g., provide the infrastructure for or a portion of the infrastructure for), support, and/or run/execute one or more applications, virtual machines (VMs), software containers, software tools, software functions, software algorithms, software models (e.g., artificial intelligence and machine learning models, software models implementing one or more classical algorithms, etc.), software applications, software packages, domains, databases, networks, services, workloads, service chains, functions, controllers, virtual network functions (VNFs), servers, drivers, hardware and/or software resources, software and/or hardware devices, software and/or hardware nodes, networking elements, serverless environments, serverless functions, cloud services and/or applications (e.g., software-as-a-service, function-as-a-service, infrastructure-as-a-service, platform-as-a-service, cloud applications, and/or any other cloud services and/or applications), execution environments, storage systems, processing/compute systems, memory systems, software and/or network sites, software policies, virtual/logical networks, overlay networks, software-defined networks (SDNs), interfaces, and/or any other code, component, element, application, service, etc.

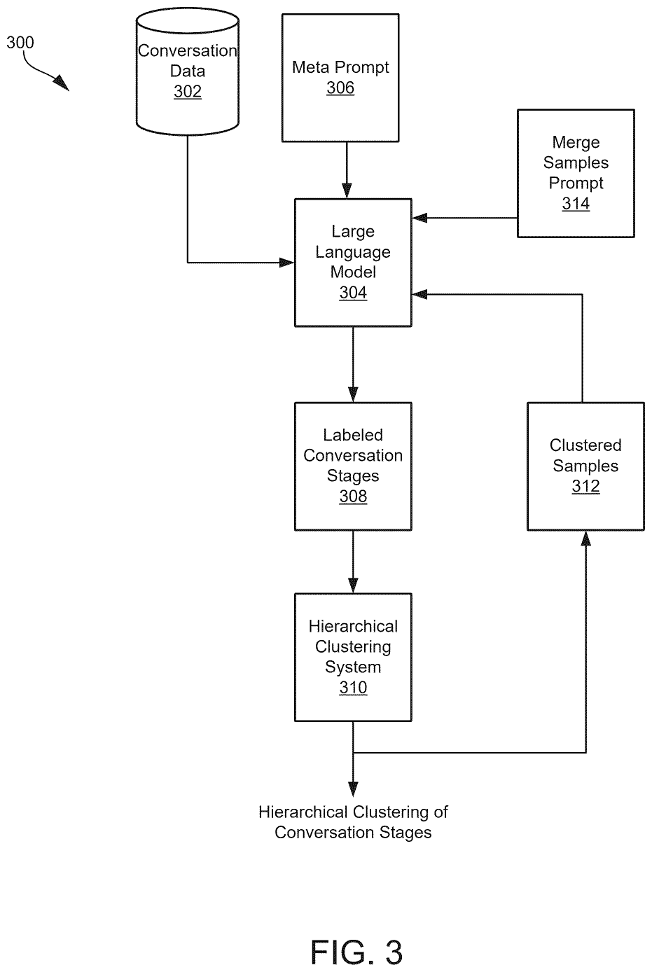

For example, the network architecture 150 can include, represent, implement, support, run, host, and/or provide the infrastructure for (or a portion of the infrastructure for) a datacenter, network (e.g., a cloud or cloud network, an on-premises network, a private network, a public network, a hybrid network, etc.), network infrastructure, and/or network environment used to host, implement, support, deploy, provide, and/or run quality control workloads/nodes, such as the worker nodes and the master node shown in FIG. 3 (and further described below). In such examples, the master node and each of the worker nodes can implement, include, represent, support, run, host, and/or provide one or more software applications/services, software systems, software packages, software modules, software units, software tools, interfaces, software/application code, functions, virtual environments, virtual applications, execution environments, virtualization elements (e.g., operating system-level virtualization elements, application-level virtualization elements, etc.), platforms, and/or any other components. In some cases, the master node and/or one or more of the worker nodes (or all) can each host and run one or more software containers, VMs, VNFs, applications (e.g., container applications, VM applications, and/or any other software applications), operating systems (OSs), functions, tools, and/or any other execution environment, code, tool, component, element, and/or package.

As shown in FIG. 1B, the network architecture 150 can include a network fabric 155. The network fabric 155 can include and/or represent the physical layer (e.g., underlay) and/or infrastructure of the network architecture 150. In some cases, the network fabric 155 can represent a data center(s) of one or more networks such as, for example, one or more cloud networks. The network fabric 155 can include network devices 160A-N (collectively referred to as “network devices 160” hereinafter) and network devices 162A-N (collectively referred to as “network devices 162” hereinafter), which are interconnected to route, relay, forward, and/or switch traffic in the network fabric 155. In some examples, the network devices 160 and the network devices 162 can include, implement, represent, and/or operate as switches (e.g., Layer 2 and/or Layer 3 switches, aggregation switches, ingress and/or egress switches, top-of-rack (ToR) switches, core switches, spine switches, leaf switches, etc.), routers, hubs, bridges, gateways, provider edge devices, firewalls, network controllers, and/or any other type of networking devices. In FIG. 1B, the network fabric 155 includes or implements a spine-leaf topology. In such examples, the network devices 160 can represent spine nodes (e.g., spine switches or routers) and the network devices 162 can represent leaf nodes (e.g., leaf switches or routers). In other examples, the network fabric 155 can alternatively or additionally include or implement any other network topology.

The network devices 160 are interconnected with the network devices 162, and the network devices 162 can connect the network 118, the system servers 126 (e.g., including QC system(s) 130 and configuration system(s) 132), the network device 165, the nodes 170, and/or the node 175 with any portion of the network fabric 155 (e.g., including each other), the media device(s) 106, the content servers 120, an external network(s), a network overlay(s), a logical network(s), a network portion(s) or branch/branches, an external device(s), a service chain(s), a data center(s), a cloud network(s), and/or any other network(s) and/or compute/network element(s). In some cases, the network fabric 155 can include, host, and/or implement a network overlay(s) or logical network(s) that includes or implements one or more application services, servers, VMs, software containers, virtual resources (e.g., storage, memory, processors, network interfaces, virtual tools, execution environments, etc.), workloads, functions, virtual networks, hardware and/or software resources, and/or any other element(s).

Network connectivity in the network fabric 155 can flow from the network devices 160 to the network devices 162, and vice versa. The network devices 162 can route, switch, relay, forward, and/or bridge network traffic to and from other portions of the network fabric 155, other networks, e.g. network 118, various network elements, the network device 165, the nodes 170, the node 175, external client devices (e.g., clients devices external to the network fabric 155), data centers, clouds, tunnels, software-defined networks (SDNs) and/or SDN branches, on-premises networks, cloud tenants, cloud customers, applications, and/or any other network element. Thus, the network devices 162 can connect networks and network elements of the network fabric 155 with each other and with other networks and network elements.

In FIG. 1B, the system servers 126 can include or represent computer servers. Each of the system servers 126 can host, include, implement, and/or run one or more applications, functions, services, VMs, software containers, service chains, workloads, AI/ML models, algorithms, resources, cloud appliances, and/or any other software. In some cases, the system servers 126 connected to the network devices 162 can encapsulate and decapsulate packets to and from the network devices 162. For example, the system servers 126 can include, host, implement and/or operate one or more virtual routers, switches, gateways, endpoints, and/or network devices for tunneling packets between an overlay or logical layer hosted by, or connected to, the system servers 126 and an underlay layer represented by or included in the network fabric 155.

As shown in FIG. 1B, the system servers 126 can host, include, run, operate, and/or implement the nodes 170 and the node 175. In some examples, the nodes 170 and the node 175 can represent cloud instances. For example, in some cases, the nodes 170 and the node 175 can each represent a virtual server and/or environment (e.g., a VM, a software container, etc.) that uses compute, memory, storage, and/or networking resources on the cloud (e.g., network architecture 150) for respective workloads. In some embodiments, the nodes 170 and/or the node 175 can perform parallel computing using, for example, multithreading. Each of the nodes 170 and/or the node 175 can include, host, implement, run, operate, and/or represent one or more server applications, software containers, VMs, software, services, AI/ML models, algorithms, cloud appliances, software functions, service chains, workloads, server-side functions, processing resources, computers, and/or any other software and/or hardware component.

For example, in some cases, each of the nodes 170 and/or the node 175 can represent a node instance that includes, implements, hosts, and/or runs a software container(s). The software container associated with a node can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). In some cases, the nodes 170 and the node 175 can represent cloud node instances running respective computing environments, such as software containers or VMs. Each VM can include software, services, drivers, applications, libraries, functions, virtualized resources (e.g., processors, memory, storage, network interfaces, etc.), and/or workloads installed, implemented, included, and/or running/executed on a guest operating system (OS) associated with the VM.

The network architecture 150 can deploy, run, implement, host, and/or support various resources (e.g., hosts, applications, services, functions, VMs, software containers, workloads, cloud appliances, service chains, hardware and/or software resources, AI/ML models, algorithms, application platforms, operating systems, etc.) using the system servers 126, the network fabric 155, the network devices 160, the network devices 162, the network device 165, the nodes 170, the node 175, and the network 118.

In some cases, the network architecture 150 can implement and/or can be part of one or more cloud networks and can provide one or more cloud computing services such as, for example and without limitation, cloud storage, serverless computing, software-as-a-service (SaaS) (e.g., streaming services, content delivery services, video services, Internet content services, application services, conferencing services, etc.), infrastructure-as-a-service (IaaS), platform-as-a-service (PaaS) (e.g., web services, streaming services, content delivery services, content library services, conferencing services, video services, Internet content services, sharing and/or collaboration services, etc.), function-as-a-service (FaaS), and/or any other types of services such as desktop-as-a-service (DaaS), information technology management-as-a-service (ITaaS), managed software-as-a-service (MSaaS), mobile backend-as-a-service (MBaaS), etc.

The network architecture 150 described above illustrates a non-limiting example network architecture provided herein for explanation purposes. It should be noted that other network architectures can be implemented in other examples and are also contemplated herein. One of ordinary skill in the relevant art(s) will recognize in view of the disclosure that other network architectures can be used to implement one or more of the concepts, systems, techniques, devices, software, applications, methods, embodiments, elements, examples, and/or components disclosed herein.

Various embodiments of the subject technology can be implemented through the cloud computing architecture 100 shown in FIG. 1A and the network architecture 150 shown in FIG. 1B. In particular, LLMs and other applicable models and applications can be implemented through the architectures 100 and 150 for performing prompt engineering and hierarchical clustering. As follows, the prompts can be applied in communication applications that use virtual agents in suggesting responses in conversation. Specifically, a communication application with a virtual agent can be implemented through the architectures 100 and 105 shown in FIGS. 1A and 1B. A live human agent can then join and continue the conversation.

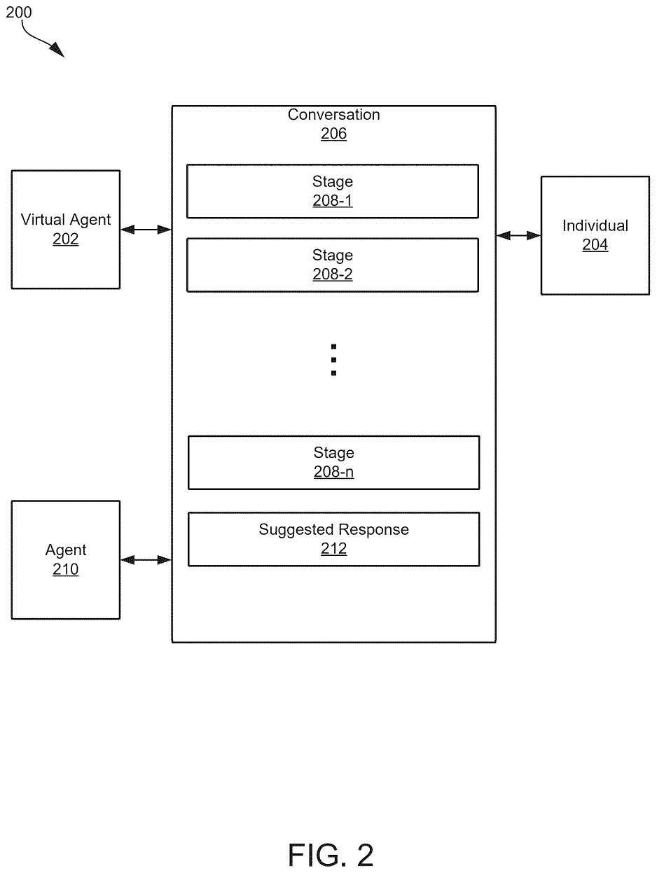

FIG. 2 illustrates a schematic diagram of a communication environment 200 that is maintained with an application that allows for both virtual agent 202 and agent 210 interaction with an individual 204, according to some examples of the present disclosure. A virtual agent 202, as used herein, can include a software program that interacts with a person, e.g. the individual 204, in a conversation. Specifically, the virtual agent 202 can send messages to a person to start and maintain a conversation as if the virtual agent was an actual human. Virtual agents can be implemented through LLMs, finite state machines (FSMs), rule-based systems, and other applicable artificial intelligence models, e.g. models that use machine learning and natural language processing. For example, virtual agents can be implemented by organizations to interact with customers. Specifically and as discussed previously, interactions can occur until a human agent becomes involved and continues the conversation.

In the example communication environment 200 shown in FIG. 2, the virtual agent 202 and the individual begin the conversation 206. The conversation 206 is structured with different stages comprising first stage 208-1, second stage 208-2 . . . to stage 208-n (collectively referred to as “stages 208”). A stage of a conversation, as used herein, can comprise one or more words and characters that semantically form a concept, a thought, some form of human expression, or a combination thereof in a conversation. Words and symbols that form a stage of a conversation can be put forth by a single participant in the conversation. For example, the virtual agent 202 can first ask the individual in the first stage 208-1 of the conversation 206, what their reason is for contacting an organization. Further in the example, the individual 204 can respond the virtual agent's 202 question in the second stage 208-2 of the conversation 206. This back and forth can continue throughout the stages 208 of the conversation 206.

Conversations, as used herein, can include an overall context that is associated with the conversation. Context of a conversation can include any words and characters exchanged during the conversation, circumstances associated with messages conveyed during a conversation, characteristics of participants in the conversation, characteristics of organizations associated with the conversation, and other applicable characteristics that can be used in interpretating all or portions of the conversation. Context of a conversation can be specific to individual stages of a conversation. For example, a context of an initial stage of a conversation can include an initial support question that is asked. Context of a stage can also depend on previous stages, e.g. contexts associated with previous stages. For example, if a customer responds in a subsequent stage to an initial support question, then the context of the subsequent stage can include the customers answer as well as that the answer was given in response to the initial support question.

Returning back to the example communication environment 200 shown in FIG. 2, a human agent 210 can join the conversation 206 after the virtual agent 202 and the individual have communicated through the stages 208 of the conversation 206. As the agent 210 can enter the conversation 206 lacking knowledge of the previous stages 208 of the conversation 206 and the associated contexts therewith, it can be difficult for the agent 210 to quickly join and continue the conversation 206 with the individual 204. As a result, a suggested response 212 can be generated and presented to the agent 210. In turn, the agent can choose whether to send the suggested response 212 to the individual 204 and continue the conversation. The suggested response can be generated through the technology described herein in relation to prompt engineering. Specifically, the suggested response can be generated based on the contexts of the conversation 206 and the stages 208 and a hierarchical clustering of previous conversation stages.

The disclosure now turns to a discussion of generating a hierarchical clustering of conversation stages. The hierarchical cluster of conversation stages can be used to generate a prompt which can then be used to generate a suggested response for a communication.

FIG. 3 illustrates a schematic diagram of an architecture 300 for generating a hierarchical clustering of conversation stages, according to some examples of the present disclosure. The architecture 300 comprises conversation data 302 that is a dataset of different conversations. The conversations included as part of the conversation data 302 can comprise conversations between virtual agents and individuals. Further, the conversations included as part of the conversation data 302 can include conversations with multiple stages. Additionally, the conversations included as part of the conversation data 302 can include conversations with varying contexts across the conversations and the stages within the conversations. The conversation data 302 can be specific to an organization or exist across various organizations. For example, the conversation data 302 can include conversations between virtual agents and individuals in performing information technology service requests for a specific organization.

The architecture 300 comprises an LLM 304 that receives the conversation data 302. The LLM 304 functions to infer contextual labels for stages of the conversations included in the conversation data 302. A contextual label, as used herein, can comprise applicable information describing a context associated with a stage. Such information can be in the form of a natural language description, e.g. such that the contextual label can be understood by a human or a model that understands natural language, e.g. an LLM. A contextual label can include a description of meaning of words or symbols in a stage of a conversation. For example, a contextual label can include that a virtual agent is asking a customer for an order number. Further, a contextual label can include a description of meaning of words or symbols in a stage of a conversation with respect to previous stages in the conversation. For example, a contextual label can include that a virtual agent is asking a customer for an order number in response to the customer previously indicating that their order was lost. Data included in a contextual label can include information for inferring instructions for responding in a stage of a conversation. For example, the contextual label that a virtual agent is asking for an order number in response to a customer indicating that their order was lost can be used in inferring instructions specifying to ask the customer for their order number in response to the lost order.

The architecture 300 comprises a meta prompt 306. The meta prompt can instruct the LLM 304 to generate data about conversation data. Specifically, the meta prompt 306 can specify for the LLM 304 to create a contextual label for each stage of a conversation that is included in the conversation data 302. For example, the meta prompt 306 can instruct the LLM 304 to generate a five to six word natural language label to describe a stage of a conversation with respect to previous stages in the conversation. In turn, the LLM 304 can create contextual labels based on the meta prompt 306 Further, the meta prompt 306 can instruct the LLM 304 to specify whether the stage is a message from an agent or a message from an individual interacting with the agent. As follows, the LLM 304 can add to a contextual label whether the stage in the conversation is at an agent or an individual interacting with the agent. For example, the LLM 304 can specify in a contextual label for a stage that a customer has inquired about the status of their order. Further in the example, the LLM 304 can specify in a contextual label for a later stage that an agent has responded to the customer about the status of their order.

In the architecture 300, labeled conversation stages 308 are output by the LLM 304 from the conversation data 302 in response to the meta prompt 306. In various embodiments, different LLMs can be applied to generate the labeled conversation stages 308. As a result, unique contextual labels can be created that are unique to the specific LLMs used in generating the labels. This can account for diversity amongst different LLMs and allow for the implementation of the technology described herein across the different LLMs. This is advantageous as different organizations can implement the technology with their desired LLM.

The labeled conversation stages 308 serve as input to the hierarchical clustering system 310. As follows, the hierarchical clustering system 310 can cluster the labeled conversation stages 308 into a hierarchical clustering. Specifically, the hierarchical clustering system 310 can cluster the labeled conversation stages 308, otherwise referred to as samples, into the hierarchical clustering based on the contextual labels that are inferred by the LLM 304 for the conversation stages. More specifically, the hierarchical clustering system 310 can cluster labeled conversation stages into nodes of the hierarchical clustering based on the associated contextual labels.

In forming the hierarchical clustering, the hierarchical clustering system 310 can arrange the nodes in a tree structure with nodes extending downwards such that each node has a single parent node and one or more child nodes. The nodes can be arranged in the tree structure based on contextual granularity or specificity of contextual labels assigned to the stages or samples that are grouped into each node. Specifically, the stages with more general contextual labels can form the root nodes at the top of the tree structure. As follows, the stages with the more specific contextual labels can form parent nodes and child nodes under the root nodes in the tree structure. This can also be referred to as agglomerative clustering, where nodes are merged from the bottom-up to form the tree structure. This clustering can be done one layer at a time as a hierarchical approach.

Further, in forming the hierarchical clustering, the hierarchical clustering system 310 can arrange conversation stages based on an order of the stages in the conversations. Such order can correspond to a granularity of specific of the contextual labels assigned to the stages. Therefore, in grouping the stages based on conversation order, the hierarchical clustering system 310 can arrange the stages based on contextual specificity or granularity. For example, the hierarchical clustering system 310 can cluster the first stages of the conversation that are generic or semi-generic messages in a conversation at the top of the hierarchical clustering, e.g. as root nodes.

The hierarchical clustering system 310 can cluster the labeled conversation stages 308 based on a similarity criterion applied to contextual labels associated with the stages. The similarity criterion can include an applicable measure or principle for quantifying or qualifying similarities between conversation stages based on contextual labels. Specifically, the similarity criterion can be implemented by semantically comparing the contextual labels associated with the conversation stages 308 and then grouping the conversation stages based on semantically similarity between the labels. For example, the hierarchical clustering system 310 can cluster together conversation stages that include a virtual agent asking a customer the status of their order based on contextual labels describing the virtual agent asking about order status. In another example, the hierarchical clustering system 310 can cluster together conversation stages that include a virtual agent communicating with a customer about a return of an order based on contextual labels describing a return order query. The generated hierarchical clustering of conversation stages can, as will be discussed in greater detail later, used in generating a prompt for an LLM to suggest a response in a conversation.

The architecture 300 shown in FIG. 3 includes a loop that can be used to refine the hierarchical clustering of conversation stages generated by the hierarchical clustering system 310. The loop includes gathering clustered samples 312 from the hierarchical clustering of conversation stages. The clustered samples 312 can include conversation stages that are clustered together into a single node in the hierarchical clustering of conversation stages. Further, the clustered samples 312 can include conversation stages that are clustered across multiple nodes in the hierarchical clustering of conversation stages. The clustered samples 312 can be clustered together through recursive merging or another applicable approach. Specifically, the clustered samples 312 can be clustered based on various similarity measures.

The clustered samples 312 can be fed as input to the LLM 304 as part of the feedback loop of the architecture 300. A merge samples prompt 314 can also be provided as input to the LLM 304. The merge samples prompt 314 can instruct the LLM 304 to merge samples of the clustered samples 312. Further, the merge samples prompt 314 can instruct the LLM 304 to infer contextual labels for the merged samples.

The LLM 304 can merge the clustered samples 312 to form merged samples in response to the merge samples prompt 314, e.g. as part of the feedback loop. The clustered samples 312 that are selected and then merged by the LLM 304 can span across an applicable number of different conversations. Further, the clustered samples 312 that are selected and then merged by the LLM 304 can span across an applicable number of nodes. As a result, all or portions of different conversations can be merged by the LLM 304 to form merged conversations as part of the merged samples. For example, the child nodes in conversations under a root node of an order status being unfulfilled can be selected and merged to form the merged conversations. The LLM 304 can then infer contextual labels for the merged samples in response to the merge samples prompt 314.

The merged samples and contextual labels for the merged samples can be provided, as labeled conversation stages 308 in the loop, to the hierarchical clustering system 310. The hierarchical clustering system 310 can then hierarchically cluster the merged samples based on the contextual labels to generate a modified portion of the hierarchical clustering of conversation stages. The hierarchical clustering of conversation stages can then be updated to include the modified portion with clustered merged samples and create a refined hierarchical clustering. This loop can be repeated an applicable number of times with any subset of samples to further refine the hierarchical clustering. As follows, the refined hierarchical clustering can be used in generating a prompt for an LLM to suggest a response in a conversation.

In generating a refined hierarchical clustering, conversation stages can be clustered into different nodes from the original hierarchical clustering. Specifically, stages can be relabeled and matched with other stages that are more similar in the refined clustering, resulting in a more accurate clustering of the conversation stages. As follows, when stages of a current conversation are mapped to the refined hierarchy to generate a prompt, the stages can be mapped to stages in the hierarchy that are more similar. In turn, this can result in creation of a prompt that is more accurate, e.g. more applicable to the current conversation.

This loop of re-clustering and relabeling can be performed continuously, at set times, or within specific time windows. This loop can be performed to rebalance the clusters, so that the tree is not heavily skewed towards a side (for binary, left/right) leading to a balanced structure. In turn this can lead to improved performance in comparison to unbalanced structure. Specifically, without balancing of the tree through the performance of the loop, the final result, e.g. the prompt, can be heavily skewed towards a few samples.

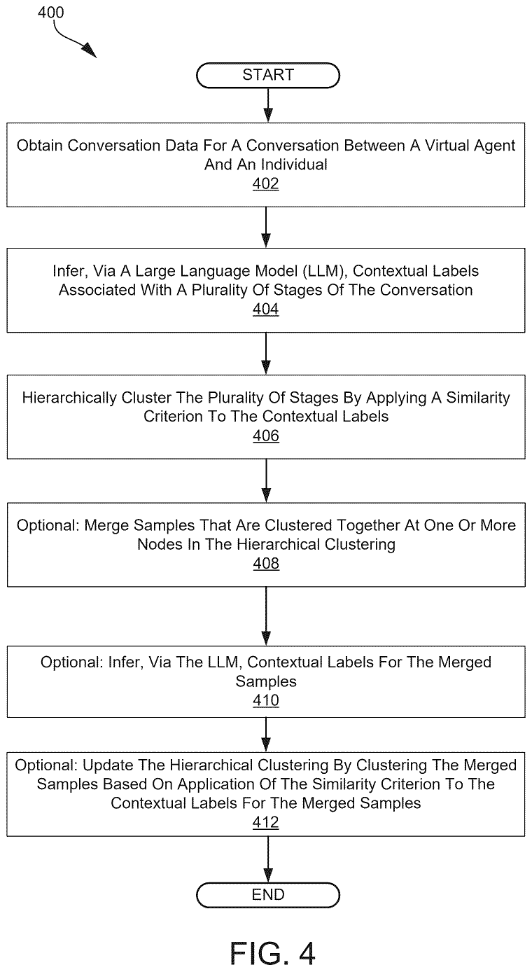

FIG. 4 illustrates a flowchart 400 of an example method of generating a hierarchical clustering of stages of conversations, according to some examples of the present disclosure. The hierarchical clustering of stages can be used in generating prompts for inferring suggested communications in conversations, according to the technology described herein. The method shown in FIG. 4 is provided by way of example, as there are a variety of ways to carry out the method. Additionally, while the example method is illustrated with a particular order of steps, those of ordinary skill in the art will appreciate that FIG. 4 and the modules shown therein can be executed in any order and can include fewer or more modules than illustrated. Each module shown in FIG. 4 represents one or more steps, processes, methods or routines in the method. The modules will be discussed with respect to the example environments described herein.

At module 402, conversation data for a conversation between a virtual agent and an individual is obtained. The conversation data can form part of a corpus of conversations between agents and individuals. Such conversations in the corpus can include conversations between human agents and individual and virtual agents and individuals.

At module 404, contextual labels associated with a plurality of stages of the conversation are inferred, via an LLM. Specifically, the LLM can receive a meta prompt specifying to infer contexts associated with stages in the conversation and infer contextual labels for the stages. As follows, the LLM can, in response to the meta prompt, can identify contexts for the plurality of stages and infer contextual labels for each of the plurality of stages based on the contexts. The context and corresponding contextual labels for each of the stages can depend on an overall context of the conversation, e.g. up to each specific stage in the conversation. Therefore, the contextual labels for the stages of the conversation can depend on contexts associated with previous stages in the conversation. Using an LLM to infer contexts and corresponding contextual labels for stages in a conversation is technically advantageous in that it eliminates the need for human involvement in the labeling of stages of a conversation. Such human involvement is tedious and time consuming, in particular when large number of conversations are labeled. Further, such human involvement can introduce bias in the labeling process. Therefore, using an LLM to infer contextual labels for stages of a conversation is technically advantageous in that human resources can be conserved and potential sources of bias can be eliminated.

At module 406, the plurality of stages are hierarchically clustered by applying a similarity criterion to the contextual labels. Specifically, the stages can be clustered with stages from other conversations based on the similarity criterion to create a hierarchical clustering. The similarity criterion can be based on semantics, such that stages can be clustered together based on semantic similarity in the contextual labels that are given to the stages by the LLM.

Modules 404 and 406 can be performed across different LLMs. Specifically, a first LLM can be applied to the conversation data to infer the contexts and corresponding contextual labels for the stages of the conversation. As follows, a first hierarchical clustering can be generated based on the contextual labels that are inferred by the first LLM. Similarly, a second LLM can be applied to the conversation data to infer the contexts and corresponding contextual labels for the stages of the conversation. As follows, a first hierarchical clustering can be generated based on the contextual labels that are inferred by the first LLM. Generating different hierarchical clusterings of stages for different LLMS is technically advantageous as such clusterings can account for the differences in the LLMs. Specifically, different LLMs can create different contextual labels for the same conversation stages. By creating different hierarchical clusterings, the differences in contextual labeling amongst the different LLMs can be accounted for in ultimately generating prompts, as will be described in detail later. This also advantageous as different organizations can have different preferred LLMs. Therefore, the technology can be tailored to the LLM of choice for an organization.

At module 408, optionally, samples that are clustered together at one or more nodes in the hierarchical clustering are merged. Specifically, one or more nodes can be selected for an applicable reason. For example, if suggested responses that are generated based on matchings to one or more specific nodes are irrelevant, or the nodes are otherwise not performing well for use in generating suggested the response, then the specific nodes can be selected. After the nodes are selected, the samples clustered at the nodes can be merged together to form merged samples.

At module 410, optionally, contextual labels for the merged samples are inferred. Specifically, the merged samples can be provided as input back to the LLM. The LLM, in response to the meta prompt, can then infer contexts of the merged samples. As follows, the contexts of the merged samples can be used by the LLMs to infer contextual labels for the merged samples. Effectively, the LLM can create contextual labels for conversation stages that are merged across different conversations.

At module 412, optionally, the hierarchical clustering is updated by clustering the merged samples based on application of the similarity criterion to the contextual labels for the merged samples. Specifically, the merged samples can be clustered based on the contextual labels, e.g. as a subset of the hierarchical clustering. As follows, all or portions of the hierarchical clustering can be replaced by the newly clustered merged samples, e.g. the subset of the hierarchical clustering can replace a portion or otherwise be inserted into the clustering to generate a refined hierarchical clustering. Refining the hierarchical clustering by merging samples and re-clustering the merged samples is technically advantageous in that it can lead to the more accurate matching of samples, e.g. from nodes that are not performing well. As follows, this can lead to more accurate prompt generation for a given conversation and more accurate response generation for the conversation based on such prompt.

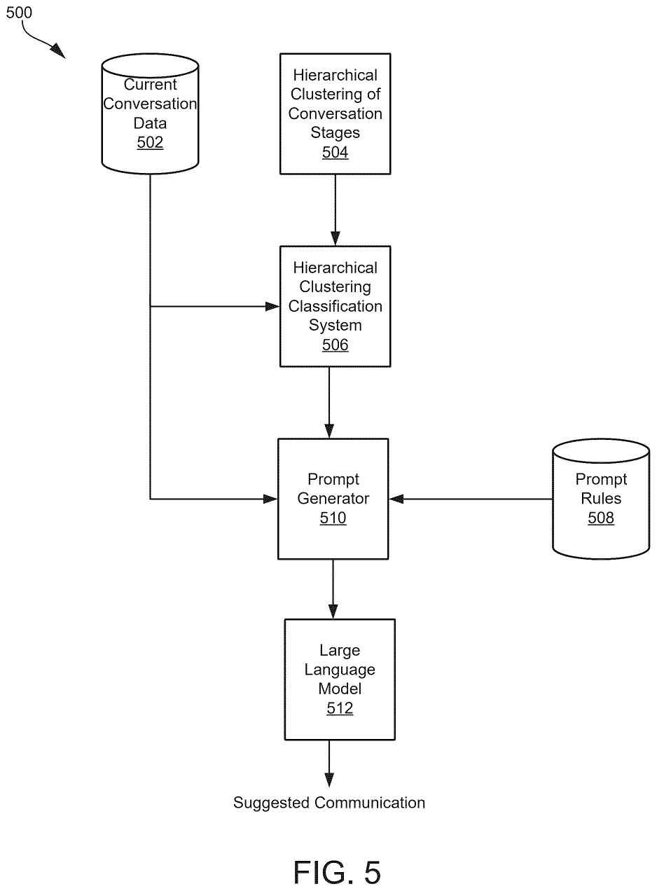

FIG. 5 illustrates an architecture 500 for generating a prompt for generating a suggested communication in a conversation through application of a hierarchical clustering of conversation stages, according to some examples of the present disclosure. The architecture includes a current conversation stored as current conversation data 502. The current conversation can be a conversation between a virtual agent and an individual, such as represented in the communication environment 200 shown in FIG. 2. Specifically, the current conversation can have multiple stages between the virtual agent and the individual. Further, a human agent can have just joined the conversation to replace the virtual agent. Accordingly, the architecture 500 shown in FIG. 5 can be implemented in order to generate a suggested response for the human agent to communicate to the individual.

The architecture 500 also includes a hierarchical clustering of conversation stages 504. The hierarchical clustering of conversation stages 504 can be generated according to the technology described herein. Specifically, the hierarchical clustering of conversation stages 504 can be generated separate from the current conversation.

The architecture 500 includes a hierarchical clustering classification system 506. The hierarchical clustering classification system 506 functions to classify stages in a current conversation to nodes in the hierarchical clustering of conversation stages 504. Specifically, the hierarchical clustering classification system 506 can select stages in the current conversation to classify to the hierarchical clustering of conversation stages 504. As follows, the hierarchical clustering classification system 506 can classify the selected stages to nodes in the hierarchical clustering of conversation stages 504.

The hierarchical clustering classification system 506 can traverse the hierarchical clustering of conversation stages 504 from the top to the bottom. For example, the hierarchical clustering classification system 506 can start by classifying a first or early stage of the current conversation to a root node in the hierarchical clustering of conversation stages 504. Then, the hierarchical clustering classification system 506 can traverse down the tree and try to classify a subsequent stage in the current conversation to a child node. In matching the current conversation to nodes in the hierarchical clustering of conversation stages 504, the hierarchical clustering classification system 506 can classify the current conversation stages to nodes based on similarity, e.g. semantic similarity, between the current conversation stages and stages clustered in the nodes. For example, the hierarchical clustering classification system 506 can semantically match natural language contextual labels of current conversation stages to contextual labels of stages in the nodes of the hierarchical clustering of conversation stages 504.

Further, the hierarchical clustering classification system 506 can classify stages in the current conversation to nodes in the hierarchical clustering of conversation stages 504 by balancing across the nodes. Specifically, the hierarchical clustering classification system 506 can balance across nodes by traversing nodes, e.g. child nodes, that contain a greater number of stages clustered at the nodes. For example, if node A has 150 stages clustered at the node and node B has 50 stages clustered at the node, then the hierarchical clustering search system can traverse to node A and classify a stage in the current conversation to node A.

The hierarchical clustering classification system 506 can traverse the hierarchical clustering based on a specific level of contextual granularity for matching or otherwise classifying nodes. Such contextual granularity can specify how many layers in the hierarchical clustering of conversation stages 504 to traverse when classifying the current conversation to nodes in the hierarchical clustering. For example, a specific level of granularity can include 1 root node, 1 parent node, and 2 child nodes. In turn, the hierarchical clustering classification system 506 can classify the current conversation to 1 root node and 2 child nodes in the hierarchical clustering of conversation stages 504. Further, contextual granularity can specify a number of stages to classify in a conversation. Contextual granularity can be set by an individual or an organization.

The architecture 500 includes a prompt generator 510. The prompt generator 510 functions to generate a prompt for an LLM for generating a suggested communication for the current conversation. The prompt generator 510 can generate the prompt based on the hierarchical clustering of conversation stages 504. Specifically, the prompt generator 510 can generate the prompt based on the nodes in which the current conversation is classified in the hierarchical clustering of conversation stages 504 by the hierarchical clustering classification system 506. More specifically, the prompt generator 510 can add the information of the stages in one or more child nodes, e.g. leaf nodes, in the hierarchical clustering to which the stages in the current conversation are classified. For example, if stages in the current conversation are classified to a path that ends in child nodes A and B in the hierarchical clustering, then the prompt generator 510 can add the information of the stages in nodes A and B, into the prompt. Information of stages in a node in the hierarchical clustering that are added to the prompt can include the contextual labels of the stages in the node, the contextual description of the stages in the node, and stage instructions for stages in the node. Stage instructions of a stage, as used herein, can include instructions that are followed by an LLM in responding as part of the stage. The prompt generator 510 can also include the current conversation data in the generated prompt. This current conversation data can be used in inferring a suggested communication based on the prompt.

The prompt generator can implement prompt rules 508 in generating the prompt for an LLM. The prompt rules 508 can specify applicable conditions for generating a prompt for a LLM to generate a response to the current conversation. For example, a prompt rule can specify to not ask the customer for any personal information. In another example, a prompt rule can specify to only respond using information from an existing chat. The prompt rules can be organization specific, thereby allowing organization to customize prompt generation.

The following illustrates an example of a prompt that can be generated according to the technology described herein.

You are a helpful assistant who follows the RULES and the provided instructions exactly. Understand the CONTEXT, and follow the NOTE:

RULES:
DO respond only using the information from the existing chat.
DO ask questions to understand the issue, if not present in the chat.
DO NOT ask for any personal information of the customer. Existing personal information in the chat can be used to respond.

Below in <external_knowledge> is most relevant knowledge from knowledge base articles that may help respond to the customer. Only use the below, if relevant and necessary.
<external_knowledge>
{{search_context}}
</external_knowledge>

Below in the <current_chat> is the ongoing conversation, to which a response needs to be generated.
<current_chat>
{{current_chat}}
</current_chat>

Understand what <stage> the <current_chat> is in, of the ones defined in <stage_descriptions>:
<stage_descriptions>
   <stage>
      <title>GREETING</title>
      <description>Once the Agent joins the chat, they greet the customer before understanding & trying to resolving their issue.</description>
   </stage>
   <stage>
      <title>UNDERSTANDING CONTEXT & ISSUE(s)</title>
      <description>Once the Agent greeted the customer, they understand the issue and all the relevant information.</description>
   </stage>
   <stage>
      <title>RESOLVING ISSUE(s) & COMMUNICATING SOLUTION</title>
      <description>Once the necessary context is gathered, and the issue is understood well, the Agent tries to resolve the issue and communicate the solution. This may involve proposing multiple solutions until the customer confirms they no longer have the issue, or the Agent has handed off the issue to a different party.</description>
   </stage>
   <stage>
      <title>WRAP-UP</title>
      <description>Once the Agent has either resolved the issue, redirected it, or provided some other conclusion, they check with customer if they have any other issues before wrapping up the conversation.</description>
   </stage>
</stage_descriptions>

Once a <stage> is identified from <stage_descriptions>, respond based on the respective instructions in <stage_instructions>:
<stage_instructions>
   <stage>
      <title>GREETING</title>
      <instruction>Based on the time of the day (look at the previous message's timestamp), greet the customer and ask how you can be of assistance.</instruction>
   </stage>
   <stage>
      <title>UNDERSTANDING CONTEXT & ISSUE(s)</title>
      <instruction>If the customer has already described their problem, confirm & clarify your understanding of the problem. If more information is needed, use the external (knowledge provided)[#external_knowledge] to ask the relevant questions.</instruction>
   </stage>
   <stage>
      <title>RESOLVING ISSUE(s) & COMMUNICATING SOLUTION</title>
      <instruction>Use the (knowledge provided)[#external_knowledge] to propose solution, check if it worked or consider redirecting to the relevant party.</instruction>
   </stage>
   <stage>
      <title>WRAP-UP</title>
      <instruction>Check if the customer has any other issue, and if they do, go back to the previous stages. If no other issue, wish the customer before ending the conversation.</instruction>
   </stage>
</stage_instructions>

Given the <current_chat>, the next message will be from the agent. Recommend a response by categorizing the <current_chat> into a <stage> based on <stage_description>, and give the predicted <stage> in JSON key: “stage”, and explain your reasoning behind choosing that stage in JSON key: “reasoning”. Using the predicted <stage>, follow the respective <stage_instructions> and recommend a response the Agent can use in JSON key: “response”.

This is the output format:
{
   “stage”: . . . (Pick one of the <stage>),
   “reasoning”: . . . (Why that <stage>?),
   “response”: . . . (Response recommendation according to <stage_instructions> for predicted <stage>)
}

The prompt generator 510 can provide the generated prompt to the LLM 512. The LLM 512 can be the same LLM that was used in labeling conversation stages for creating the hierarchical clustering of conversation stages 504. The LLM functions to use the prompt to generate a suggested communication for the current conversation. The suggested communication can then be presented to a human agent who joins the conversation. The human agent can then decide whether to send the communication to the individual in the current conversation who has been conversing with the virtual agent.

In inferring the suggested communication from the prompt, the LLM 512 can access current conversation data included in the prompt and use the current conversation data to identify a context of the current conversation. As follows, the LLM 512 can use the context of the current conversation to classify the current conversation, e.g. classify a current stage of the current conversation. Specifically, the LLM 512 can match a current stage of the current conversation to a stage included in one of the nodes, e.g. child nodes, that are matched to the current conversation and included in the prompt. For example, the current conversation can be matched through the hierarchical clustering to nodes A and B in the clustering. As follows, information of the stages in nodes A and B can be included in the prompt that is provided to the LLM. The LLM can then determine a context of a current stage of the current conversation and match it, or otherwise classify it, to a stage in one of nodes A and B.

Once the LLM 512 has classified a current conversation to a stage included in the prompt, the LLM can generate a suggested response based on the stage. Specifically, information in the prompt can include instructions that are associated with the stages from the hierarchical clustering that are included in the prompt. Therefore, the LLM can access, through the prompt, the instructions that are associated with the stage to which the current conversation is classified. The LLM 512, can then use these instructions to generate a suggested communication for the current conversation.

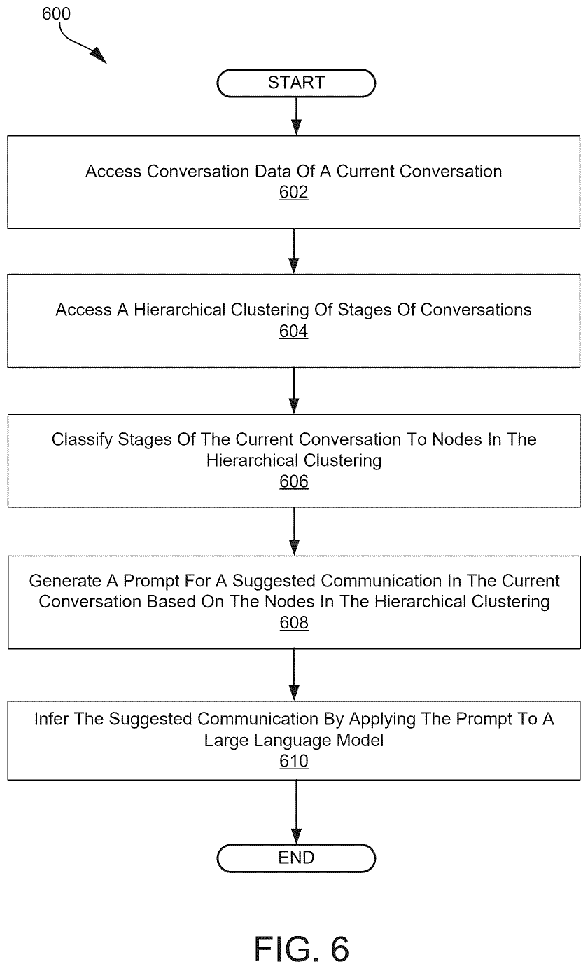

FIG. 6 illustrates a flowchart 600 of an example method of generating a prompt through a hierarchical clustering of stages of conversations for inferring a suggested communication in a current conversation, according to some examples of the present disclosure. The method shown in FIG. 6 is provided by way of example, as there are a variety of ways to carry out the method. Additionally, while the example method is illustrated with a particular order of steps, those of ordinary skill in the art will appreciate that FIG. 6 and the modules shown therein can be executed in any order and can include fewer or more modules than illustrated. Each module shown in FIG. 6 represents one or more steps, processes, methods or routines in the method. The modules will be discussed with respect to the example environments described herein.

At module 602, conversation data of a current conversation is accessed. The current conversation can include a conversation between a virtual agent and an individual. Specifically, the current conversation can include one or more stages between the virtual agent and the individual. Further, a human agent can join the conversation and be presented with a suggested communication that is generated based on the context of the conversation and corresponding stages of the conversation.

At module 604, a hierarchical clustering of stages of conversations is accessed. The hierarchical clustering of stages of conversations can be built through different conversation from the current conversation. Further, the hierarchical clustering can be generated based on contexts associated with the conversations and stages of the conversations through the technology described herein.

At module 606, stages of the current conversation are classified to nodes in the hierarchical clustering. Specifically, stages of the current conversation can be classified to the nodes in the hierarchical clustering based on contexts of the stages of the current conversation and contexts associated with the stages at the nodes in the hierarchical clustering. More specifically, contextual labels of stages in the current conversation can be matched to the nodes based on contextual labels of the stages included in the nodes. Such nodes can include one or more child nodes in the hierarchical clustering.

At module 608, a prompt for a suggested communication in the current conversation is generated based on the nodes in the hierarchical clustering. Specifically, the prompt can be generated based on the nodes that the current conversation is classified to in the hierarchical clustering. More specifically, the prompt can include the information of the stages in child nodes that the current conversation is classified to in the hierarchical clustering. This information can include the contextual labels of the stages, descriptions of the stages, and instructions associated with generating the communications as part of the stages. It is technically advantageous to generate a prompt through the hierarchical clustering, as the prompt can be generated specifically for the current conversation. As follows, this can result in the generation of a suggested response that is more applicable for the current conversation and more appropriate based on a current state and context of the current conversation. Further, this can be done with little to no human intervention, thereby saving time and human resources.

At module 610, the suggested communication is inferred by applying the prompt to an LLM. Specifically, the LLM can match/classify the current conversation to a stage of a child node included in the prompt. As follows, the stage of the child node can be used to generate the suggested communication. For example, instructions associated with the stage of the child node can be implemented, based on the context of the current conversation, to generate a suggested response. The LLM can match the current conversation to the stage of the child node based on context of the current conversation, e.g. of a current stage of the current conversation, and a context of the stage of the child node.

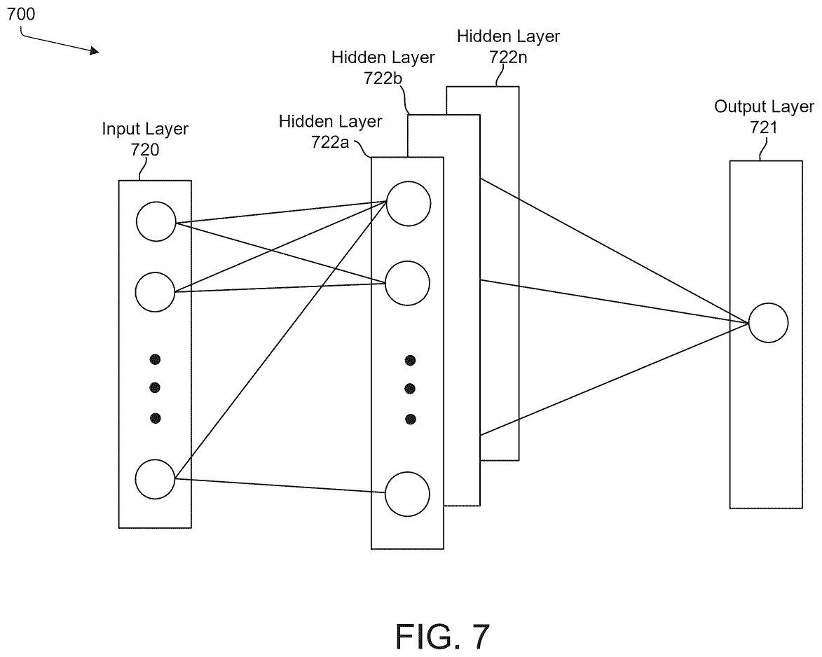

In FIG. 7, the disclosure now turns to a further discussion of models that can be used to implement the technology described herein. FIG. 7 is an example of a deep learning neural network 700 that can be used to implement all or a portion of the systems and techniques described herein, according to some examples of the present disclosure. An input layer 720 can be configured to receive sensor data and/or data relating to an environment surrounding an AV. Neural network 700 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. Neural network 700 further includes an output layer 721 that provides an output resulting from the processing performed by the hidden layers 722a, 722b, through 722n.

Neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the first hidden layer 722a can transform the information of each input node by applying activation functions to the input node information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 721, at which an output is provided. In some cases, while nodes in the neural network 700 are shown as having multiple output lines, a node can have a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a, 722b, through 722n in order to provide the output through the output layer 721.

In some cases, the neural network 700 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 700 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 700 can perform a backward pass by determining which inputs (weights) most contributed to the loss of the network, and can adjust the weights so that the loss decreases and is eventually minimized.

The neural network 700 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 700 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

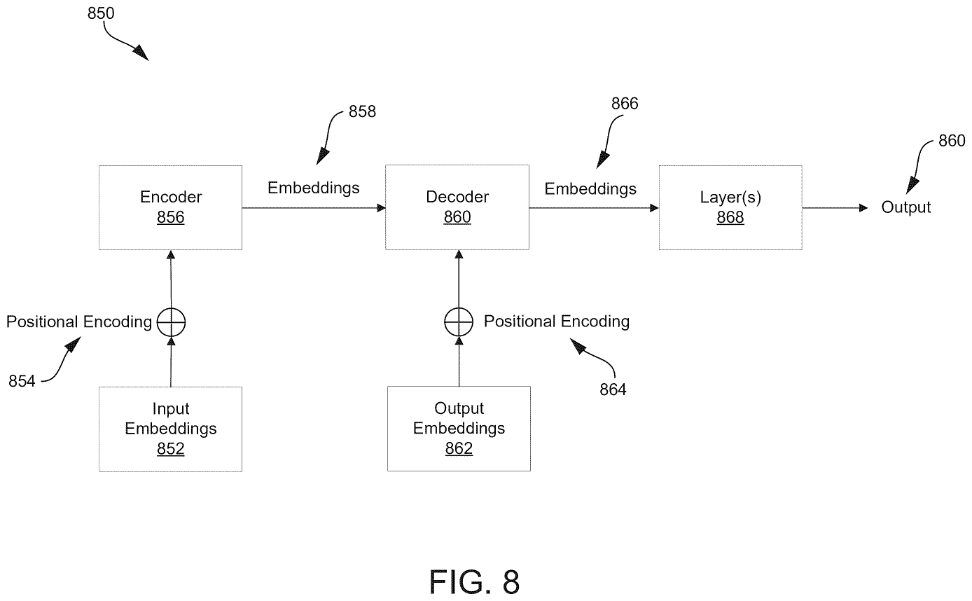

FIG. 8 is a diagram illustrating an example architecture of an example transformer model 850, according to some examples of the present disclosure. The transformer model 850 can be used to implement an LLM that can be used to implement the technology described herein. As shown, the transformer model 850 can include input embeddings 852 used as inputs to the transformer model 850. The input embeddings 852 can include input values representing words and/or sentences, such as numbers or vectors representing words and/or sentences.

In some cases, the input embeddings 852 can function like a dictionary that helps the transformer model 850 understand the meaning of words by placing them in an embedding space where similar words are located near each other. In some examples, the input interface 134 can be trained and/or configured to create the input embeddings 852 so that similar vectors represent words with similar meanings. In some examples, the transformer model 850 can additionally or alternatively learn to create and/or process the input embeddings 852 during training.

The transformer model 850 can use positional encoding 854 to encode the position of each word in an input sequence from the input embeddings 852 as values such as a set of numbers, a vector, etc. The values generated by the positional encoding 854 can be fed into the transformer model 850 along with the input embeddings 852. By incorporating the positional encoding 854 into the transformer model 850, the transformer model 850 can more effectively understand the order of words in a sentence and generate grammatically correct and semantically meaningful output.

The transformer model 850 can include an encoder(s) 856 used to process the positionally encoded input embeddings 852 and generate embeddings 858. The encoder(s) 856 can be part of the transformer model 850 that processes input text and generates hidden states that capture the meaning and context of the text. For example, the encoder(s) 856 can include a feed-forward neural network that is part of the transformer model 850. In some examples, the encoder(s) 856 can implement multiple encoder layers. In some cases, the encoder(s) 856 can first tokenize the input text into a sequence of tokens, such as individual words or subwords. The encoder(s) 856 can then apply one or more self-attention layers, which can generate hidden states that represent the input text at different levels of abstraction. In this way, the encoder(s) 856 can generate the embeddings 858 (e.g., a vector, a set of values, etc.) representing the semantics and position of words in one or more sentences.

The transformer model 850 can include output embeddings 862, which can include values representing words and/or sentences, such as numbers or vectors representing words and/or sentences. The output embeddings 862 can be similar to the input embeddings 852 and can also be processed by positional encoding 864 to encode the position of each word in a sequence from the output embeddings 862 as values such as a set of numbers, a vector, etc., which helps the transformer model 850 understand the order of words in a sentence. The output embeddings 862 can be used during a training phase of the transformer model 850 and can be used during an inference phase. During training, a loss function can be computed based on the output embeddings 862 and used to update the model parameters to improve the accuracy of the transformer model 850. During an inference phase, the output embeddings 862 can be used to generate the output text by mapping the predicted probabilities determined by the transformer model 850 for each token to the corresponding token in the vocabulary.

The positionally encoded input embeddings 852 (e.g., the embeddings 858) and the positionally encoded output embeddings 862 can be fed to a decoder(s) 860 used to generate the output sequence based on the encoded input sequence. During training, the decoder(s) 860 can learn how to guess the next word of a sequence by looking at the words before it. In some examples, the decoder(s) 860 can generate natural language text based on the input sequence and any learned context.

The decoder(s) 860 can generate embeddings 866 and feed the embeddings 866 to one or more network layers 868. In some examples, the one or more network layers 868 can include a linear layer and a softmax function. The linear layer can map the embeddings 866 generated by the decoder(s) 860 to a higher-dimensional space, which can transform the embeddings 866 into the original input space. The softmax function can then be applied to generate a probability distribution for each output token in the vocabulary, which can result in an output 870. In some examples, the output 870 can include output tokens with probabilities.

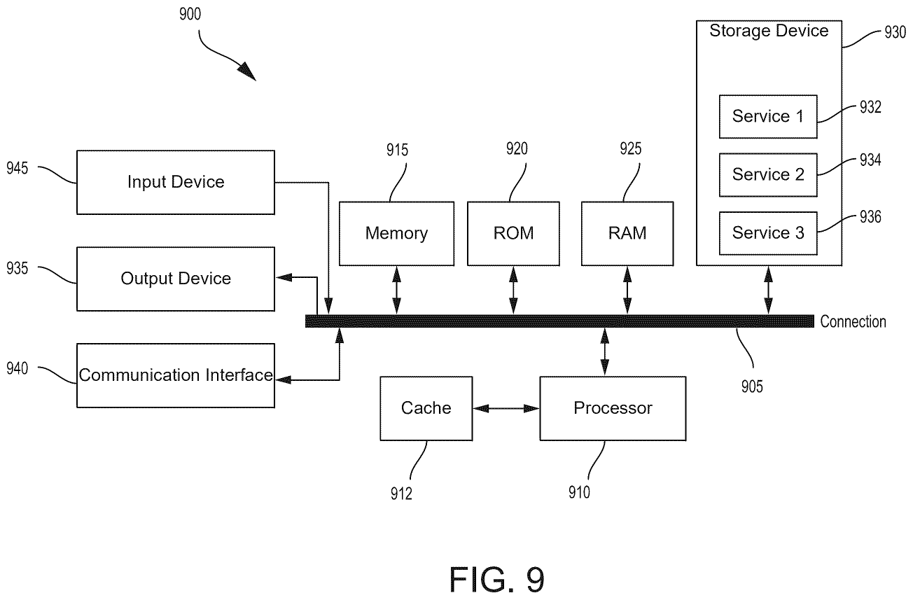

FIG. 9 illustrates an example processor-based system with which some embodiments of the subject technology can be implemented. For example, processor-based system 900 can be any computing device making up, or any component thereof in which the components of the system are in communication with each other using connection 905. Connection 905 can be a physical connection via a bus, or a direct connection into processor 910, such as in a chipset architecture. Connection 905 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 900 includes at least one processing unit (Central Processing Unit (CPU) or processor) 910 and connection 905 that couples various system components including system memory 915, such as Read-Only Memory (ROM) 920 and Random-Access Memory (RAM) 925 to processor 910. Computing system 900 can include a cache of high-speed memory 912 connected directly with, in close proximity to, or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms known to those of skill in the art. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 930 can include software services, servers, services, etc., that when the code that defines such software is executed by the processor 910, it causes the system 900 to perform a function. In some embodiments, a hardware service that performs a particular function can include the software component stored in a computer-readable medium in connection with the necessary hardware components, such as processor 910, connection 905, output device 935, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Illustrative examples of the disclosure include:

Embodiment 1. A computer-implemented method comprising: obtaining conversation data indicating a conversation between a virtual agent and an individual; inferring, via a large language model (LLM) based on the conversation data, a plurality of contextual labels respectively associated with a plurality of stages of the conversation; and hierarchically clustering the plurality of stages by applying a similarity criterion to the plurality of contextual labels.

Embodiment 2. The computer-implemented method of Embodiment 1, further comprising generating a prompt based on the hierarchical clustering for generating a suggested communication in a current conversation.

Embodiment 3. The computer-implemented method of either of Embodiments 1 or 2, further comprising: accessing conversation data of the current conversation to identify one or more stages in the current conversation; applying the hierarchical clustering based on the one or more stages in the current conversation to generate the prompt for the suggested communication in the current conversation; and applying the prompt to the LLM to infer the suggested communication based on the prompt.

Embodiment 4. The computer-implemented method of Embodiment 3, further comprising: classifying the one or more stages in the current conversation to one or more nodes in the hierarchical clustering based on labels describing contexts associated with stages clustered at the one or more nodes in the hierarchical clustering; and generating the prompt based on the one or more nodes in the hierarchical clustering.

Embodiment 5. The computer-implemented method of either of Embodiments 3 or 4, further comprising classifying the one or more stages in the current conversation to the one or more nodes in the hierarchical clustering by balancing across the one or more nodes in the hierarchical clustering based on numbers of stages grouped into the one or more nodes.

Embodiment 6. The computer-implemented method of any of any of Embodiments 3 through 5, further comprising classifying the one or more stages in the current conversation to the one or more nodes in the hierarchical clustering based on a selected level of context granularity.

Embodiment 7. The computer-implemented method of any of Embodiments 1 through 6, further comprising generating the prompt for the suggested communication based on one or more rules controlling prompt generation through application of the hierarchical clustering.

Embodiment 8. The computer-implemented method of any of Embodiments 1 through 7, wherein the current conversation is between the virtual agent and an individual and the suggested communication is a communication for an actual agent to send after replacing the virtual agent, the method further comprising: presenting the suggested communication to the actual agent; and receiving instructions from the actual agent indicating whether to send the suggested communication to the individual as part of the conversation.

Embodiment 9. The computer-implemented method of any of Embodiments 1 through 8, further comprising: accessing additional conversation data of additional conversations comprising stages; and hierarchically clustering the plurality of stages with the stages of the additional conversations in the hierarchical clustering by applying the similarity criterion to contextual labels associated with the stages of the additional conversations and the plurality of contextual labels associated with the plurality of stages of the conversation.

Embodiment 10. The computer-implemented method of Embodiment 9, wherein applying the similarity criterion further comprises semantically comparing the contextual labels associated with the stages of the additional conversations and the plurality of contextual labels associated with the plurality of stages of the conversation.

Embodiment 11. The computer-implemented method of either of Embodiments 9 or 10, further comprising: identifying a subset of the stages that are grouped together at a first node in a level of the hierarchical clustering; merging the subset of the stages to form merged conversations of the subset; inferring, through the LLM applied to the merged conversations, contextual labels for each stage of the subset of stages in the merged conversations; performing hierarchical clustering of the subset of stages based on the contextual labels to generate a modified subset of the hierarchical clustering corresponding to the subset of stages; and updating the hierarchical clustering based on the modified subset of the hierarchical clustering.

Embodiment 12. The computer-implemented method of Embodiment 11, wherein a stage in the subset of stages is clustered into a second node different from the first node in the modified subset of the hierarchical clustering.

Embodiment 13. The computer-implemented method of either of Embodiments 11 or 12, further comprising applying the updated hierarchical clustering to generate a prompt for inferring a suggested communication in a current conversation.

Embodiment 14. The computer-implemented method any of Embodiments 1 through 13, further comprising: providing a meta prompt to the LLM for performing a task of generating the contextual labels for the plurality of stages of the conversation; and providing the conversation data to the LLM, wherein the LLM is configured to infer the contextual labels of the plurality of stages of the conversation from the conversation data in response to the meta prompt.

Embodiment 15. A system comprising: one or more processors; and at least one computer-readable storage medium having stored therein instructions which, when executed by the one or more processors, cause the one or more processors to: obtain conversation data indicating a conversation between a virtual agent and an individual; infer, via a large language model (LLM) based on the conversation data, a plurality of contextual labels respectively associated with a plurality of stages of the conversation; and hierarchically cluster the plurality of stages by applying a similarity criterion to the plurality of contextual labels.

Embodiment 16. The system of Embodiment 15, wherein the instructions are further configured to cause the one or more processors to: access conversation data of a current conversation to identify one or more stages in the current conversation; apply the hierarchical clustering based on the one or more stages in the current conversation to generate a prompt for a suggested communication in the current conversation; and apply the prompt to the LLM to infer the suggested communication based on the prompt.

Embodiment 17. The system of Embodiment 16, wherein the instructions are further configured to cause the one or more processors to: match the one or more stages in the current conversation to one or more nodes in the hierarchical clustering based on labels describing contexts associated with stages clustered at the one or more nodes in the hierarchical clustering; and generate the prompt based on the one or more nodes in the hierarchical clustering that are matched to the one or more stages in the current conversation.

Embodiment 18. The system of any of Embodiments 15 through 17, wherein the instructions are further configured to cause the one or more processors to: access additional conversation data of additional conversations comprising stages; and hierarchically cluster the plurality of stages with the stages of the additional conversations in the hierarchical clustering by applying the similarity criterion to contextual labels associated with the stages of the additional conversations and the plurality of contextual labels associated with the plurality of stages of the conversation.

Embodiment 19. The system of Embodiment 18, wherein applying the similarity criterion further comprises semantically comparing the contextual labels associated with the stages of the additional conversations and the plurality of contextual labels associated with the plurality of stages of the conversation.

Embodiment 20. A non-transitory computer-readable storage medium storing instructions for causing one or more processors to: obtain conversation data indicating a conversation between a virtual agent and an individual; infer, via a large language model (LLM) based on the conversation data, a plurality of contextual labels respectively associated with a plurality of stages of the conversation; and hierarchically cluster the plurality of stages by applying a similarity criterion to the plurality of contextual labels.

Embodiment 21. A system comprising means for performing a method according to any of Embodiments 1 through 14.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computer-implemented method comprising:
obtaining conversation data indicating a conversation between a virtual agent and an individual;
inferring, via a large language model (LLM) based on the conversation data, a plurality of contextual labels respectively associated with a plurality of stages of the conversation; and
hierarchically clustering the plurality of stages by applying a similarity criterion to the plurality of contextual labels.

2. The computer-implemented method of claim 1, further comprising generating a prompt based on the hierarchical clustering for generating a suggested communication in a current conversation.

3. The computer-implemented method of claim 2, further comprising:
accessing conversation data of the current conversation to identify one or more stages in the current conversation;
applying the hierarchical clustering based on the one or more stages in the current conversation to generate the prompt for the suggested communication in the current conversation; and
applying the prompt to the LLM to infer the suggested communication based on the prompt.

4. The computer-implemented method of claim 3, further comprising:
classifying the one or more stages in the current conversation to one or more nodes in the hierarchical clustering based on labels describing contexts associated with stages clustered at the one or more nodes in the hierarchical clustering; and
generating the prompt based on the one or more nodes in the hierarchical clustering.

5. The computer-implemented method of claim 4, further comprising classifying the one or more stages in the current conversation to the one or more nodes in the hierarchical clustering by balancing across the one or more nodes in the hierarchical clustering based on numbers of stages grouped into the one or more nodes.

6. The computer-implemented method of claim 4, further comprising classifying the one or more stages in the current conversation to the one or more nodes in the hierarchical clustering based on a selected level of context granularity.

7. The computer-implemented method of claim 2, further comprising generating the prompt for the suggested communication based on one or more rules controlling prompt generation through application of the hierarchical clustering.

8. The computer-implemented method of claim 2, wherein the current conversation is between the virtual agent and an individual and the suggested communication is a communication for an actual agent to send after replacing the virtual agent, the method further comprising:
presenting the suggested communication to the actual agent; and
receiving instructions from the actual agent indicating whether to send the suggested communication to the individual as part of the conversation.

9. The computer-implemented method of claim 1, further comprising:
accessing additional conversation data of additional conversations comprising stages; and
hierarchically clustering the plurality of stages with the stages of the additional conversations in the hierarchical clustering by applying the similarity criterion to contextual labels associated with the stages of the additional conversations and the plurality of contextual labels associated with the plurality of stages of the conversation.

10. The computer-implemented method of claim 9, wherein applying the similarity criterion further comprises semantically comparing the contextual labels associated with the stages of the additional conversations and the plurality of contextual labels associated with the plurality of stages of the conversation.

11. The computer-implemented method of claim 9, further comprising:
identifying a subset of the stages that are grouped together at a first node in a level of the hierarchical clustering;
merging the subset of the stages to form merged conversations of the subset;
inferring, through the LLM applied to the merged conversations, contextual labels for each stage of the subset of stages in the merged conversations;
performing hierarchical clustering of the subset of stages based on the contextual labels to generate a modified subset of the hierarchical clustering corresponding to the subset of stages; and
updating the hierarchical clustering based on the modified subset of the hierarchical clustering.

12. The computer-implemented method of claim 11, wherein a stage in the subset of stages is clustered into a second node different from the first node in the modified subset of the hierarchical clustering.

13. The computer-implemented method of claim 11, further comprising applying the updated hierarchical clustering to generate a prompt for inferring a suggested communication in a current conversation.

14. The computer-implemented method of claim 1, further comprising:
providing a meta prompt to the LLM for performing a task of generating the contextual labels for the plurality of stages of the conversation; and
providing the conversation data to the LLM, wherein the LLM is configured to infer the contextual labels of the plurality of stages of the conversation from the conversation data in response to the meta prompt.

15. A system comprising:
one or more processors; and
at least one computer-readable storage medium having stored therein instructions which, when executed by the one or more processors, cause the one or more processors to:
obtain conversation data indicating a conversation between a virtual agent and an individual;
infer, via a large language model (LLM) based on the conversation data, a plurality of contextual labels respectively associated with a plurality of stages of the conversation; and
hierarchically cluster the plurality of stages by applying a similarity criterion to the plurality of contextual labels.

16. The system of claim 15, wherein the instructions are further configured to cause the one or more processors to:
access conversation data of a current conversation to identify one or more stages in the current conversation;
apply the hierarchical clustering based on the one or more stages in the current conversation to generate a prompt for a suggested communication in the current conversation; and
apply the prompt to the LLM to infer the suggested communication based on the prompt.

17. The system of claim 16, wherein the instructions are further configured to cause the one or more processors to:
match the one or more stages in the current conversation to one or more nodes in the hierarchical clustering based on labels describing contexts associated with stages clustered at the one or more nodes in the hierarchical clustering; and
generate the prompt based on the one or more nodes in the hierarchical clustering that are matched to the one or more stages in the current conversation.

18. The system of claim 15, wherein the instructions are further configured to cause the one or more processors to:
access additional conversation data of additional conversations comprising stages; and
hierarchically cluster the plurality of stages with the stages of the additional conversations in the hierarchical clustering by applying the similarity criterion to contextual labels associated with the stages of the additional conversations and the plurality of contextual labels associated with the plurality of stages of the conversation.

19. The system of claim 18, wherein applying the similarity criterion further comprises semantically comparing the contextual labels associated with the stages of the additional conversations and the plurality of contextual labels associated with the plurality of stages of the conversation.

20. A non-transitory computer-readable storage medium storing instructions for causing one or more processors to:
obtain conversation data indicating a conversation between a virtual agent and an individual;
infer, via a large language model (LLM) based on the conversation data, a plurality of contextual labels respectively associated with a plurality of stages of the conversation; and
hierarchically cluster the plurality of stages by applying a similarity criterion to the plurality of contextual labels.
